(19) United States
(12) Patent Application Publication
(10) Pub. No.: US 2026/0233626 A1
(43) Pub. Date: Aug. 13, 2026

(54) FUEL HOSE AND POWER CABLE MANAGEMENT

(71) Applicant: DOVER FUELING SOLUTIONS UK LIMITED, Edinburgh (GB)

(72) Inventor: Bengt I. LARSSON, Skivarp (SE)

(21) Appl. No.: 19/150,715

(22) PCT Filed: Jan. 10, 2024
(86) PCT No.: PCT/EP2024/050471

§ 371 Date: Jul. 24, 2025

(30) Foreign Application Priority Data
Jan. 27, 2023 (SE) 2350078-8

(51) Int. Cl. B60L 53/31; B60L 53/18; B67D 7/40; H02G 11/00

(52) U.S. Cl. CPC B60L 53/31; B60L 53/18; B67D 7/40; H02G 11/006

(57) ABSTRACT

The invention relates to an electric vehicle charger (1) comprising a bottom module (2), a top module (3), a first column (4) extending in a vertical direction between the bottom module (2) and the top module (3) at a first outer side (5) of the electric vehicle charger (1), a second column (6) extending in a vertical direction between the bottom module (2) and the top module (3) at a second outer side (7) of the electric vehicle charger (1), the first outer side (5) being opposite to the second outer side (7), and a charging cable (10) attached to the bottom module (2) at a proximal end and to a connector (12) at a distal end (13), the charging cable (10) being movable between a retracted position and an extended position. The invention also relates to a fuel dispensing unit (27) for refuelling a motor vehicle.

### TECHNICAL FIELD

The invention relates to an electric vehicle charger and a fuel dispensing unit for refuelling vehicles.

### BACKGROUND ART

An electrical charger for a vehicle typically comprises a charging part standing on the ground with a display part arranged directly on the charging part or above the same. One column on each side of the charging part extends between the charging part and a top part carried by the columns. A cable used to charge the vehicle is connected to the charging part at one end and to a connector at the other end.

When the vehicle is to be charged, the driver parks the vehicle beside the electrical charger and opens the cover or cap of the vehicle. The driver then places the connector in the vehicle to begin the charging process.

A difficulty that may arise in connection with charging is that the cable does not reach to the vehicle if parked a distance from the electrical charger. The reason why the vehicle has not been parked sufficiently close to the charger may be difficulty in manoeuvring owing to a limited space round the electrical charger. To allow the cable to reach the vehicle, it is usually necessary for the driver to park his vehicle so that the side of the vehicle where the cap is positioned faces the electrical charger. It is not always known to a driver of an unfamiliar vehicle whether the filler cap is positioned on the left or right side.

This may result in the driver by mistake parking the vehicle on the wrong side of the electrical charger and thus not being able to charge the vehicle without moving it to the other side of the electrical charger since the cable does not reach all the way round the vehicle.

One way of facilitating access to the electrical charger is to provide it with a longer cable. This may, however, cause problems since a longer cable may tend to land on the ground when not used and thus get stuck in or be damaged by passing cars or other vehicles. To prevent this, the electrical charger may be provided with some kind of returning mechanism for the cable.

KR 2018/0128557 discloses a charging cable winding device for an electric vehicle charger, which is capable of rewinding a cable when charging is completed and preventing the withdrawn cable from touching the floor during the charging of an electric vehicle.

A problem common for the returning devices according to prior art as described above is their size, or their extension in or at the electrical charger, which results in bulky and complicated structures.

### SUMMARY OF THE INVENTION

It is an objective of the present invention to mitigate, alleviate or eliminate one or more of the above-identified deficiencies in the art and disadvantages singly or in any combination and solve at least the above-mentioned problems.

According to a first aspect of the invention, these and other objects are achieved, in full or at least in part, by an electric vehicle charger. The electric vehicle charger comprises a bottom module, a top module, a first column extending in a vertical direction between the bottom module and the top module at a first outer side of the electric vehicle charger, a second column extending in a vertical direction between the bottom module and the top module at a second outer side of the electric vehicle charger, the first outer side being opposite to the second outer side, and a charging cable attached to the bottom module at a proximal end and to a connector at a distal end, the charging cable being movable between a retracted position and an extended position. The electric vehicle charger is characterized in that the first column comprises an inner groove along at least a part of its length and the second column comprises an outer groove along at least a part of its length. The inner groove is adapted to accommodate a proximal portion of the charging cable when the charging cable is in the retracted position, and the outer groove is adapted to accommodate a distal portion of the charging cable when the charging cable is in the retracted position.

This is advantageous in that a robust and space-saving electric vehicle charger is provided, which enables a smooth and flexible handling of the cable. Further, it will be possible to provide a longer charging cable while still maintaining a clean look and without risking entanglement of the charging cable.

The charging cable may be adapted to extend, when in the retracted position, vertically from the bottom module within the inner groove of the first column to the top module, horizontally through the top module, vertically from the top module to the bottom module, and from the bottom module within the outer groove of the second column to a holder for the connector placed on the second outer side of the electric vehicle charger.

The first column and the second column, respectively, may extend along the entire length of the bottom module and onwards up to the top module.

The inner groove may extend along the entire length of the first column and the outer groove extends along the entire length of the second column.

The first and second column may be adapted to carry the top module.

The electric vehicle charger may further comprise cover element adapted to cover the outer groove of the second column.

The electric vehicle charger may further comprise cable handling device allowing the charging cable to be pulled out from the modules of the electric vehicle charger and is adapted to return charging cable to the modules of the electric vehicle charger.

The cable handling device may comprise a cord element attached to the top module at one end and to a sleeve enclosing the charging cable at the other end.

The sleeve may be slidably attached to the charging cable.

The cord element may be elastic or attached to the top module via a spring drum.

The cable handling device may comprise a cord element attached to a roller element at one end and to a the top module at the other end, optionally via a spring drum, the roller element being slidably arranged to the outer groove of the second column and adapted to guide the charging cable.

The cable handling device may comprise a motor connected to the cord element, the motor being adapted to feed and/or retract the cord element.

The first column and the second column, respectively, may comprise an inner groove and an outer groove.

This enables to provide an electric vehicle charger with two charging cables stored in a compact space inside the electric vehicle charger without visual impact. It is possible to provide an openwork between the two columns without seeing the charging cables when they are in the retracted position.

According to a second aspect of the invention, these and other objects are achieved, in full or at least in part, by a fuel dispensing unit for refuelling a motor vehicle. The fuel dispensing unit comprises a bottom module, a top module, a first column extending in a vertical direction from the bottom module to the top module at a first outer side of the fuel dispensing unit, a second column extending in a vertical direction from the bottom module to the top module at a second outer side of the fuel dispensing unit, the first outer side being opposite to the second outer side, the first outer side being opposite to the second outer side, and a fuel hose attached to the bottom module at a proximal end and to a fuel nozzle at a distal end, the fuel hose being movable between a retracted position and an extended position. The fuel dispensing unit is characterized in that the first column comprises an inner groove along at least a part of its length and the second module comprises an outer groove along at least a part of its length. The inner groove is adapted to accommodate a proximal portion of the fuel hose when the fuel hose is in the retracted position, and the outer groove is adapted to accommodate a distal portion of the fuel hose when the fuel hose is in the retracted position.

This is advantageous in that a robust and space-fuel dispensing unit is provided, which enables a smooth and flexible handling of the fuel hose. Further, it will be possible to provide a longer fuel hose while still maintaining a clean look and without risking entanglement of the fuel hose.

The fuel hose may be adapted to extend, when in the retracted position, vertically from the bottom module within the inner groove of the first column to the top module, horizontally through the top module, vertically from the top module to the bottom module, and from the bottom module within the outer groove of the second column to a nozzle boot for the fuel nozzle placed on the second outer side of the fuel dispensing unit.

Effects and features of the second aspect of the present invention are largely analogous to those described above in connection with the first aspect of the inventive concept. Embodiments mentioned in relation to the first aspect of the present invention are largely compatible with the further aspects of the invention.

Other objectives, features and advantages of the present invention will appear from the following detailed disclosure, from the attached claims, as well as from the drawings. It is noted that the invention relates to all possible combinations of features.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise.

As used herein, the term “comprising”, and variations of that term are not intended to exclude other additives, components, integers, or steps.

As used herein, by the term “vertically” and “vertical direction”, as well as variations of these terms, it is meant a vertical or substantially vertical direction in relation to the ground on which the electric vehicle charger or the fuel dispensing unit is placed.

As used herein, by the term “horizontally” and “horizontal direction”, as well as variations of these terms, it is meant a vertical or substantially vertical direction in relation to the ground on which the electric vehicle charger or the fuel dispensing unit is placed.

### BRIEF DESCRIPTION OF THE DRAWINGS

The above, as well as additional objects, features and advantages of the present invention, will be better understood through the following illustrative and non-limiting detailed description of embodiments of the present invention, with reference to the appended drawings, where the same reference numerals may be used for similar elements, and wherein:

FIG. 1 is a perspective view of one exemplary embodiment of an electric vehicle charger according to a first aspect of the invention.

FIG. 2 is a top view of a first and second column in the electric vehicle charger.

FIG. 3 is a perspective view of another exemplary embodiment of the electric vehicle charger according to the first aspect of the invention.

FIG. 4 is a perspective view of another exemplary embodiment of the electric vehicle charger according to the first aspect of the invention.

FIG. 5 is a perspective view of one exemplary embodiment of a fuel dispensing unit according to a second aspect of the invention.

### DETAILED DESCRIPTION OF PREFERRED EMBODIMENTS OF THE INVENTION

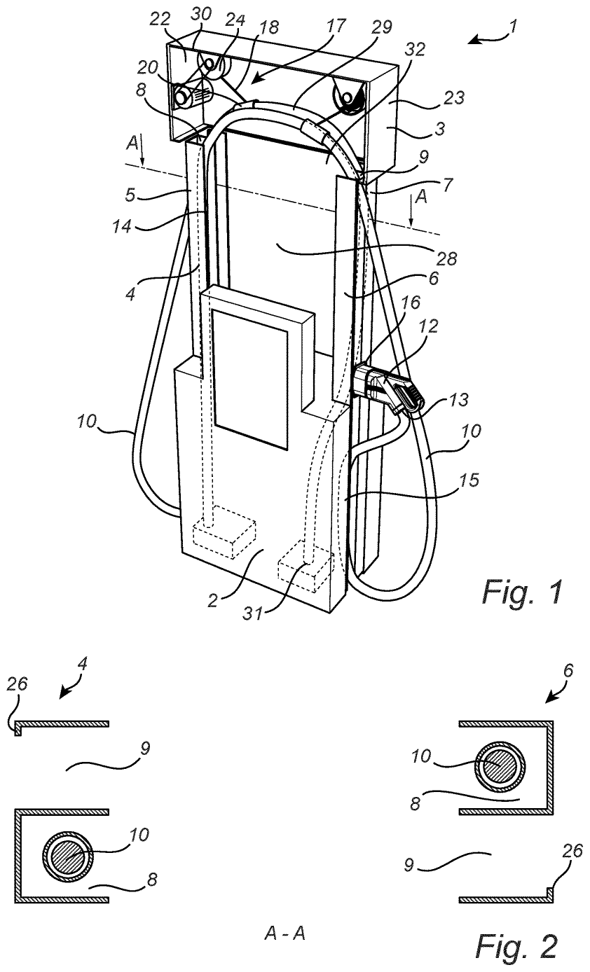

FIG. 1 illustrate an exemplary embodiment of an electric vehicle charger 1. The electric vehicle charger 1 comprises a bottom module 2 which is placed on the ground and a top module 3 placed above the bottom module 2. A first column 4 extends in a vertical direction between the bottom module 2 and the top module 3 at a first outer side 5 of the electric vehicle charger 1, and a second column 6, opposite to the first column 4, extends in a vertical direction between the bottom module 2 and the top module 3 at a second outer side 7 of the electric vehicle charger 1, opposite to the first outer side 5. The first and second columns 4, 6 are parallel. The first and second columns 4, 6 are therefore carrying the top module 3. The first column 4 comprises an inner groove 8 extending along its entire length and the second column 6 comprises an outer groove 9 extending along its length.

The inner groove 8 is oriented toward an openwork 28 positioned between the first and second columns 4, 6. The outer groove 9 is oriented to the external of the openwork 28.

A charging cable 10 is provided on each side of the electric vehicle charger 1. The charging cable 10 is attached to the bottom module 2 at a proximal end 31 and to a connector 12 at a distal end 13 and is movable between a retracted position and an extended position.

When the charging cable 10 is in the retracted position, a proximal portion 14 of the charging cable 10 is accommodated in the inner groove 8 and a distal portion 15 of the charging cable is accommodated in the outer groove 9.

Put differently, the charging cable 10, when in the retracted position, will extend vertically from the bottom module 2—where it is connected to an electric supplying module of the electric vehicle charger 1—within the inner groove 8 of the first column 4 to the top module 3, horizontally through the top module 3, vertically from the top module 3 to the bottom module 2, and from the bottom module 2 within the outer groove 9 of the second column 6 to the connector 12 placed in a holder 16 on the second outer side 7 of the electric vehicle charger 1.

A top portion 29 of the charging cable 10 is located inside the top module 3 when the charging cable 10 is in the retracted position.

The top portion 29 of the charging cable 10 is located outside the top module 3 when the charging cable 10 is in the extended position.

According to an embodiment, the top module 3 comprises a bottom wall provided with a slit extending between the first and second columns 4, 6. The top portion 29 of the charging cable 10 is crossing the slit when moving between the retracted and extended positions.

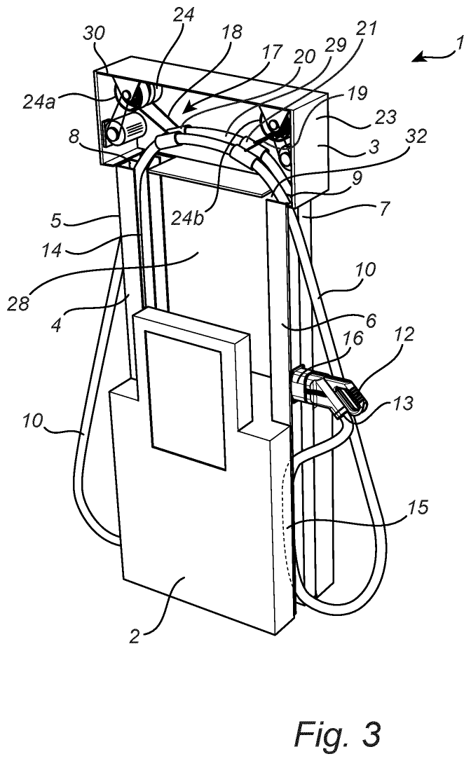

According to another embodiment shown in FIGS. 1 and 3, the top module 3 does not comprise a bottom wall. The top module 3 comprises a bottom aperture 32 allowing the top portion 29 of the charging cable 10 to move vertically.

When the charging cable 10 is in the extended position, the proximal portion 14 of the charging cable is still accommodated in the inner groove 8 but only at the lower portion of the inner groove 8 while the distal portion 15 of the charging cable 10 is pulled out laterally from the outer groove 9.

The holder 16 may be located inside the outer groove 9. The distal portion 15 of the charging cable 10 and at least a part of the connector 12 are housed in the outer groove 9 and masked for a user placed in front of the electric vehicle charger 1.

The outer groove 9 comprises a slot 26 extending vertically from the top module 3 to the bottom module 2 or more precisely from the top module 3 to the holder 16. The slot 26 is crossing the outer groove 9 of the second column 6.

The top portion 29 of the charging cable 10 will be able to cross the slot 26 between the retracted position and the extended position.

The design, function and structure of the components of the electric vehicle charger 1 described above is the same on the first outer side 5 and the second outer side 7 thereof. This means that the first column 4 and the second column 6, respectively, comprises an inner groove 8 and an outer groove 9 (see FIG. 2).

The inner groove 8 and the outer groove 9 are parallel and adjacent but oriented toward an opposite direction.

The electric vehicle charger further has a cable handling device 17 which allows the charging cable to be pulled out from the modules of the electric vehicle charger 1 and is adapted to return charging cable 10 to the modules of the electric vehicle charger 1.

FIG. 1 illustrates an embodiment in which the cable handling device 17 comprises only one cord element 18 attached to the top module 3 at one end and to a sleeve 20 enclosing the charging cable 10 at the other end. The cord element 18 is elastic or attached to the top module 3 via a spring drum 24.

The spring drum 24 comprises a spring loaded in a drum. The cord element 18 is rolled up in the spring drum 24 at the retracted position and deployed from the spring drum 24 at the extended position.

In FIG. 3, another embodiment is illustrated, in which the cable handling device 17 comprises two separate cord elements 18, 19 attached to the top module 3 at one end and to a sleeve 20, 21 enclosing the charging cable 10 at the other end. A first cord element 18 is attached to a first side 22 of a top wall 30 of the top module 3 and a second cord element 19 is attached to a second side 23 of the top wall 30, opposite to the first side 22, of the top wall 30.

Preferably, the first cord element 18 is attached to a first spring drum 24a at one end and attached to a first sleeve 20 at the other end. The second cord element 19 is attached to a second spring drum 24b at one end and attached to a second sleeve 21 at the other end. The use of two separate cord elements 18, 19 and two spring drums 24a, 24b enables to support a longer charging cable 10 that is heavier while using two identical spring drums 24a, 24b have a relatively small size instead of a single big spring drum that would be bulky.

The sleeves 20, 21 are slidably attached to the charging cable 10 but could also be fixed thereto. The cord elements 18, 19 are elastic or attached to the top module 3 via the respective spring drums 24a, 24b. Two spring drums 24a, 24b and two cord elements 18, 19 are thus used for guiding one charging cable 10. The two spring drums 24a, 24b are positioned at opposite positions into the top module 3.

In another embodiment, the cable handling device 17 is constituted by an electrical, hydraulic or pneumatical driven motor (not shown) which is connected to the charging cable and adapted to feed and retract the charging cable 10. It would also be possible to use a pneumatical or hydraulicly driven piston.

If the electric vehicle charger 1 comprises two charging cables 10, one on each side, there will naturally be one separate cable handling device 17 for each charging cable 10.

Each cable handling device 17 can comprise a single cord element 18 cooperating with a single spring drum 24 (FIG. 1) or can comprise two cord elements 18, 19 cooperating with two respective spring drums 24a, 24b (FIG. 3).

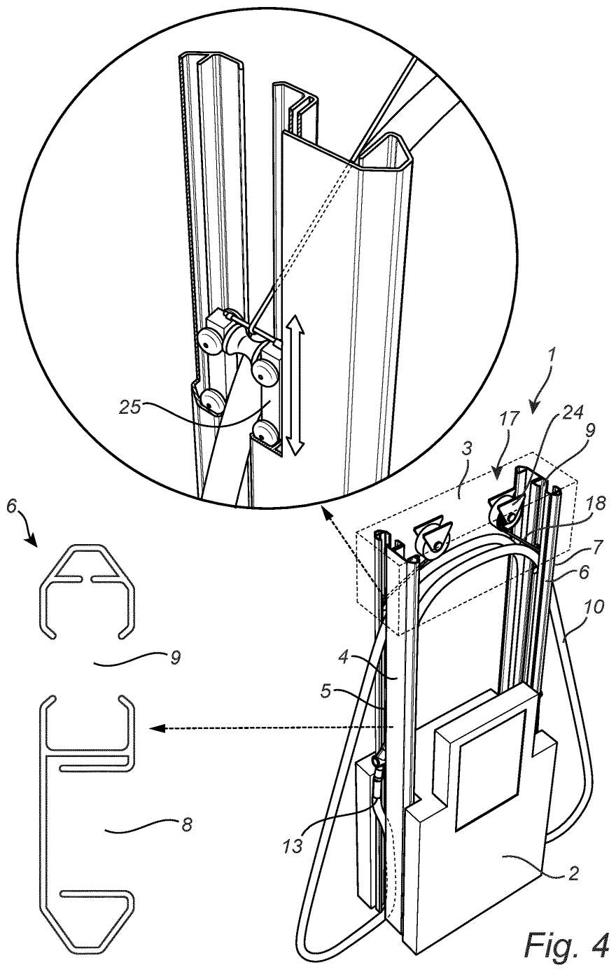

In FIG. 4, another embodiment is illustrated, in which the cable handling device 17 has a cord element 18 attached to a roller element 25 at one end and to the top module 3 at the other end, optionally via a spring drum 24. The roller element 25 is in turn slidably arranged in the outer groove 9 of the second column 6 and adapted to guide the charging cable 10. The roller element 25 may include one or several rollers to help guide the charging cable 10. It may also enclose the charging cable 10. The charging cable 10 crosses the roller element 25. The roller element 25 can slide vertically in the outer groove 9.

The different embodiments of the cable handling device 17 described above in FIG. 1, FIG. 3 and FIG. 4 may also be combined in any suitable manner.

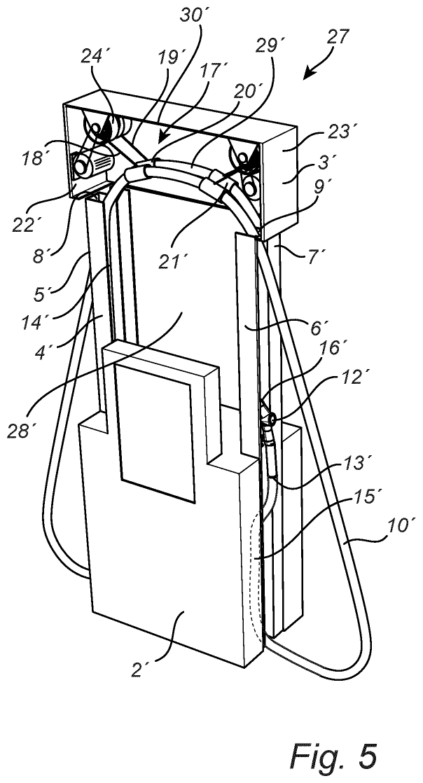

FIG. 5 illustrates an exemplary embodiment of a fuel dispensing unit 27 for refuelling of a motor vehicle. The components described above for managing the fuel hose 10′ of the fuel dispensing unit 27 correspond to the components described above and below relating to the electric vehicle charger 1.

It is understood that other variations in the present invention are contemplated and, in some instances, some features of the invention can be employed without a corresponding use of other features. Accordingly, it is appropriate that the appended claims be construed broadly in a manner consistent with the scope of the invention.

For instance, the size shape and number of the different components included in the electric vehicle charger 1 may be varied in any suitable manner as long as the objectives of the inventions is maintained.

The electric vehicle charger 1 may further comprise a cover element adapted to cover the outer groove 9 of the second column 6. The cover element is intended as an outer cover of the outer groove 9 in order to protect the charging cable 10 and preferably also keep it in place when the electric vehicle charger 1 is not in use. The cover element can be made of any type of suitable material but most preferable metal. Other exemplary materials that could be used is rubber and plastic.

In all of the embodiments described herein, both the first column 4 and the second column 6 both extend along the entire length of the bottom module 2 and onwards up to the top module 3. Also, both the inner groove 8 and the outer groove 9 extend along the entire length of the first and second column 4, 6. Other possibilities are, however, also possible. For example, the inner groove 8 and the outer groove 9 may extend along only a portion of the first and second column 4, 6.

1. An electric vehicle charger comprising:
a lower housing;
a upper housing;
a first column extending in a first direction between the lower housing and the upper housing at a first outer side of the electric vehicle charger;
a second column extending in the first direction between the lower housing and the upper housing at a second outer side of the electric vehicle charger, the first outer side being opposite to the second outer side; and
a charging cable attached to the lower housing at a first end and to a connector at a second end, the charging cable being movable between a retracted position and an extended position,
wherein
the first column comprises an inner groove along at least a part of its length and the second column comprises an outer groove along at least a part of its length, the inner groove being adapted to accommodate a first portion of the charging cable when the charging cable is in the retracted position, and the outer groove being adapted to accommodate a second portion of the charging cable when the charging cable is in the retracted position.

2. The electric vehicle charger of claim 1, wherein the charging cable is adapted to extend, when in the retracted position, from the lower housing within the inner groove of the first column to the upper housing, through the upper housing, from the upper housing to the lower housing, and from the lower housing within the outer groove of the second column to a holder for the connector placed on the second outer side.

3. The electric vehicle charger of claim 1, wherein the first column and the second column extends along the entire length of the lower housing and to the upper housing.

4. The electric vehicle charger of claim 1, wherein the inner groove extends along the entire length of the first column and the outer groove extends along the entire length of the second column.

5. The electric vehicle charger of claim 1, wherein the first and second column are adapted to carry the upper housing.

6. The electric vehicle charger of claim 1, further comprising a cover element adapted to cover the outer groove of the second column.

7. The electric vehicle charger of claim 1, further comprising a cable handling device allowing the charging cable to be pulled out from at least one of the upper housing and the lower housing and adapted to return the charging cable at least one of the upper housing and the lower housing.

8. The electric vehicle charger of claim 7, wherein the cable handling device comprises a cord attached to the upper housing at one end and to a sleeve enclosing the charging cable at an other end.

9. The electric vehicle charger of claim 8, wherein the sleeve is slidably attached to the charging cable.

10. The electric vehicle charger of claim 8, wherein the cord is elastic or attached to the upper housing via a spring drum.

11. The electric vehicle charger of claim 7, wherein the cable handling device comprises a cord attached to a carriage at one end and to the upper housing at the other end, the carriage being slidably arranged to the outer groove of the second column and adapted to guide the charging cable.

12. The electric vehicle charger of claim 7, wherein the cable handling device comprises a motor connected to the cord, the motor being adapted to feed and/or retract the cord.

13. (canceled)

14. A fuel dispensing unit for refuelling a motor vehicle, comprising:
an lower housing;
an upper housing;
a first column extending in a first direction from the lower housing to the upper housing at a first outer side of the fuel dispensing unit;
a second column extending in the first direction from the lower housing to the upper housing at a second outer side of the fuel dispensing unit, the first outer side being opposite to the second outer side; and
a fuel hose attached to the lower housing at a first end and to a fuel nozzle at a second end, the fuel hose being movable between a retracted position and an extended position,
wherein
the first column comprises an inner groove along at least a part of its length and the second module comprises an outer groove along at least a part of its length, the inner groove being adapted to accommodate a first portion of the fuel hose when the fuel hose is in the retracted position, and the outer groove being adapted to accommodate a second portion of the fuel hose when the fuel hose is in the retracted position.

15. The fuel dispensing unit of claim 14, wherein the fuel hose is adapted to extend, when in the retracted position, from the lower housing within the inner groove of the first column to the upper housing, horizontally through the upper housing, vertically from the upper housing to the lower housing, and from the lower housing within the outer groove of the second column to a nozzle boot for the fuel nozzle placed on the second outer side of the fuel dispensing unit.
